(19) United States
(12) Patent Application Publication
(10) Pub. No.: US 2010/0023875 A1
(43) Pub. Date: Jan. 28, 2010

(54) AUTOMATIC RENDERING OF USER INTERFACE ELEMENTS

(75) Inventors: Samar Choudhary, Morrisville, NC (US); Humberto Gutierrez-Rivas, Chapel Hill, NC (US); Vijay Pandiarajan, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/177,691

(22) Filed: Jul. 22, 2008

(51) Int. Cl. G06F 3/00

(52) U.S. Cl. 715/748

(57) ABSTRACT

Embodiments of the present invention address deficiencies of the art in respect to user interfaces and provide a novel and non-obvious method, system and computer program product for automatically rendering user interface elements based on predefined rules. In an embodiment of the invention, a method for automated rendering of user interface elements in a user interface can be provided. The method can include reading a plurality of rules, wherein each rule specifies criteria for automatic rendering of a user interface element in the user interface and receiving an attribute value via a data feed. The method can further include determining that the attribute value meets criteria for at least one rule and automatically rendering a user interface element in the user interface. The method can further include periodically rendering the user interface element in the user interface so as to reflect updated attribute values.

### BACKGROUND OF THE INVENTION

1. Field of the Invention

The present invention relates to the field of user interfaces and more particularly to software that facilitates network monitoring of various information feeds using user interfaces.

2. Description of the Related Art

Individuals are sometimes faced with the task of monitoring certain information feeds such as stock values, weather reports, news headlines or the status of one or more computers. In an effort to facilitate the administration of such information feeds, dashboard-like user interfaces are often used. A dashboard is a user interface that is designed to provide visual presentations of information feeds. A dashboard may obtain information from the local operating system in a computer, from one or more remote applications that may be running, and/or from one or more remote sites on a network, and present it all on one interface. Dashboard software, however, can be costly to develop, expensive to purchase, difficult to use and complicated to understand.

Another approach to monitoring multiple information feeds includes the use of mashups. A mashup is a web application that combines data or user interface elements from more than one source into a single integrated tool. Content used in mashups is typically sourced from a third party via a public interface or API (web services). Other methods of sourcing content for mashups include web feeds (e.g. RSS or Atom), and screen scraping. The architecture of a mashup web application is composed of three parts: 1) the content provider, i.e., the source of the data or the information feed, 2) the application that integrates the different data sources and 3) the client web browser or the user interface of the mashup. Mashups, however, don't come without their drawbacks.

Mashup must be developed according to the needs of individual users, which customization can be costly. Further, mashups are hard-coded to constantly present defined data sources. This is not always desirable since real estate on computer desktops is valuable and users may only desire to view select data sources in certain cases. A conventional mashup, for example, may display information for a selection of information feeds being monitored. The administrator, however, may only be interested in information feeds that meet a predefined criteria, and therefore the administrator is forced to look through all the information feeds to identify the items that he desires to monitor. This can be tedious and time-consuming.

Therefore, there is a need to overcome the deficiencies with the prior art and more particularly for a more efficient way to create and render user interface elements that monitor the multiple informational feeds.

### BRIEF SUMMARY OF THE INVENTION

Embodiments of the present invention address deficiencies of the art in respect to user interfaces and provide a novel and non-obvious method, system and computer program product for automatically rendering user interface elements based on predefined rules. In an embodiment of the invention, a method for automated rendering of user interface elements in a user interface can be provided. The method can include reading a plurality of rules, wherein each rule specifies criteria for automatic rendering of a user interface element in the user interface and receiving an attribute value via a data feed. The method can further include determining that the attribute value meets criteria for at least one rule and automatically rendering a user interface element in the user interface. The method can further include periodically rendering the user interface element in the user interface so as to reflect updated attribute values.

In another embodiment of the invention, a computer program product comprising a computer usable medium embodying computer usable program code for automated rendering of user interface elements in a user interface can be provided. The computer program product can include computer usable program code for reading a plurality of rules, wherein each rule specifies criteria for automatic rendering of a user interface element in the user interface and receiving an attribute value via a data feed. The computer program product can further include computer usable program code for determining that the attribute value meets criteria for at least one rule and automatically rendering a user interface element in the user interface. The computer program product can further include computer usable program code for periodically rendering the user interface element in the user interface so as to reflect updated attribute values.

In another embodiment of the invention, a computer for automated rendering of user interface elements in a user interface can be provided. The computer can include a data repository for storing a plurality of rules, wherein each rule specifies criteria for automatic rendering of a user interface element in the user interface. The computer can further include a receiver for receiving an attribute value via a data feed. The computer can further include a processor configured for: reading the plurality of rules; determining that the attribute value meets criteria for at least one rule; automatically rendering a user interface element in the user interface; and periodically rendering the user interface element in the user interface so as to reflect updated attribute values.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for automatically aggregating user interface components, in accordance with one embodiment of the present invention;

FIG. 2 is an illustration of a user interface including multiple user interface elements, in accordance with one embodiment of the present invention; and

FIG. 3 is a flow chart showing the control flow of a process for automatically rendering user interface elements according to predefined rules, in accordance with one embodiment of the present invention.

### DETAILED DESCRIPTION OF THE INVENTION

Embodiments of the present invention address deficiencies of the art in respect to user interfaces and provide a novel and non-obvious method, system and computer program product for automatically rendering user interface elements based on predefined rules. In an embodiment of the invention, a method for automated rendering of user interface elements in a user interface can be provided. The method can include reading a plurality of rules, wherein each rule specifies criteria for automatic rendering of a user interface element in the user interface and receiving an attribute value via a data feed. The method can further include determining that the attribute value meets criteria for at least one rule and automatically rendering a user interface element in the user interface. The method can further include periodically rendering the user interface element in the user interface so as to reflect updated attribute values.

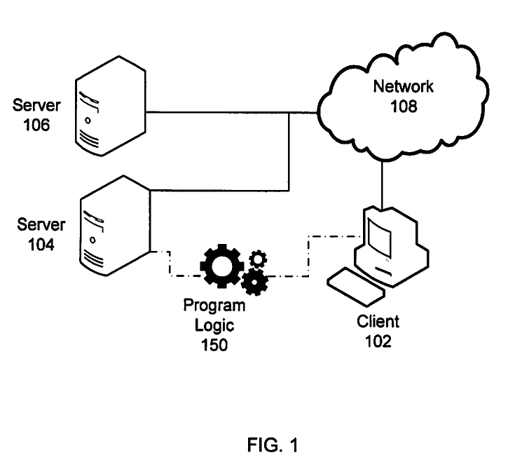

Referring now to the drawing figures in which like reference designators refer to like elements, there is shown in FIG. 1 a block diagram illustrating a network architecture of a system for automatically aggregating user interface components, in accordance with one embodiment of the present invention. The exemplary embodiments of the present invention adhere to the system architecture of FIG. 1. FIG. 1 shows an embodiment of the present invention wherein a client user 102 may interact with servers 104-106 over a network 108, such as the Internet, the World Wide Web, a WAN or a LAN.

FIG. 1 shows client user 102 and servers 104-106 connected to network 108 via computers, such as desktop personal computers, workstations or servers. Servers 104, 106 include software engines that deliver data and/or user interface component functionality to client computer 102. The servers 104-106 may adhere to any commercially available server platform, such as the Sun Microsystems J2EE platform, a Web-based application platform, an integrated platform for e-commerce or a content management system platform. It should be noted that although FIG. 1 shows only one client user 102 and two servers 104-106, the system of the present invention supports any number of client users and servers connected via network 108.

FIG. 1 shows a system whereby a client application, represented by program logic 150, running on a client 102 automatically renders user interface elements according to predefined rules. The user interface elements include information received from servers 104-106. Program logic 150 comprises computer source code, scripting language code or interpreted language code that is compiled to produce computer instructions that perform various functions of the present invention. In one embodiment of the present invention, the program logic 150 is a scripting language such as ECMAScript, Cascading style sheets, XML, XSLT, Javascript, AJAX, XUL, JSP, PHP, and ASP.

As explained above, program logic 150 may reside on a client 102, or a server (such as server 104) or any combination of the two. In one embodiment of the present invention, the program logic 150 is a client-server application having a client portion that resides on the computer of client user 102 and a server application that resides on a server, such as servers 104-106.

In an embodiment of the present invention, the computer systems of client user 102 and servers 104-106 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of client user 102 and servers 104-106 are a server system, such as IBM RS/6000 workstations and servers running the AIX operating system.

In an embodiment of the present invention, the network 108 is a circuit switched network, such as the Public Service Telephone Network (PSTN). In another embodiment, the network 108 is a packet switched network. The packet switched network is a wide area network (WAN), such as the global Internet, a private WAN, a local area network (LAN), a telecommunications network or any combination of the above-mentioned networks. In yet another embodiment, the structure of the network 108 is a wired network, a wireless network, a broadcast network or a point-to-point network.

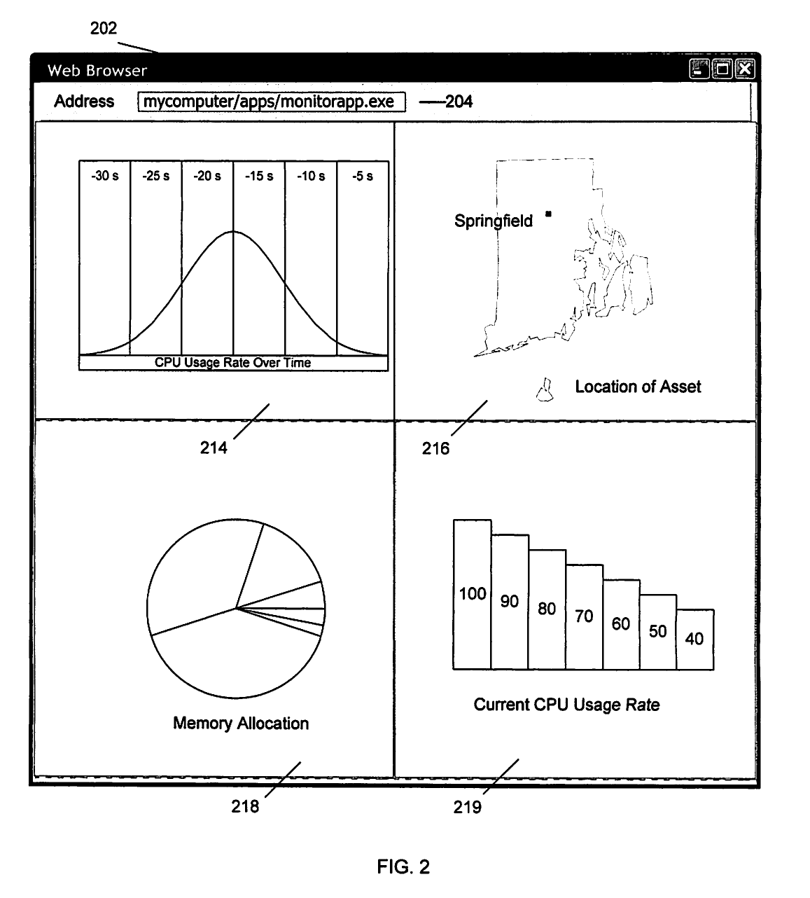

FIG. 2 is an illustration of a user interface 202 including multiple user interface elements 214, 216, 218, 219, in accordance with one embodiment of the present invention. It should be noted that although the present invention is directed towards the monitoring of any type of data feed (regarding stock values, weather updates, computer statuses, sports scores, etc.), FIG. 2 depicts one example wherein a user interface is used to monitor status information for one or more computers or servers.

FIG. 2 shows that the user interface 202 is a conventional web browser. FIG. 2 shows that the web browser 202 includes an address text field 204 that indicates a local location of an executable file on client 102 that automatically renders user interface elements according to predefined rules. User interface 202 thereby executes the executable file, which produces the graphics displayed in user interface 202, as shown in FIG. 2.

In another embodiment of the present invention, address text field 204 may indicate a Universal Resource Locator (URL) of a web site. Upon entering the appropriate URL, the web browser 202 sends a HyperText Transfer Protocol (HTTP) request for data to the appropriate web server, such as web server 106, corresponding to said URL. Subsequently, the web server 106 sends executable data to the web browser 202. The executable data received by the web browser 202 may be HTML or may comprise some or all of the program logic 150, which may be a scripting language such as XML, XSLT, Javascript, etc. Upon receiving the executable data sent by web server 106, web browser 202 executes the executable data, which produces the graphics displayed in user interface 202, as shown in FIG. 2.

As explained above, FIG. 2 shows user interface 202 including multiple user interface elements 214, 216, 218, 219 which depict status information that is received about particular servers or computers. Status information about a computer or server includes memory usage information, CPU usage information, event information and executing process information. User interface element 214 includes a graph that shows CPU usage of a computer or server over time. User interface element 216 includes a map showing a location of a computer or server. User interface element 218 includes a pie chart that shows the current allocation of memory of a computer or server. User interface element 219 includes a bar graph that shows current CPU usage of a computer or server.

For each computer or server for which status information is received, there may exist a list of attributes with accompanying attribute values, such as a “CPU usage” attribute with a defined value of 95 percent. Another example of an attribute with an accompanying attribute value is a “Memory usage” attribute with a defined value of 90 percent.

Using the attributes described above, various if-then rules can effectively be implemented over time by receiving and evaluating status information for various servers and computers. For example, the if-then rule “if the CPU usage of server A is higher than 95 percent, display a graph for server A's CPU usage” can be implemented by evaluating the current CPU usage of server A. In another example, the if-then rule “if the Memory usage of server B is lower than 5 percent, display a graph for server B's Memory usage” can be implemented by evaluating server B's Memory usage. Thus, as the status information of computers and servers change over time, the execution of if-then rules results in a constantly changing interface 202 as user interface elements (such as elements 214, 216, 218, 219) are constantly displayed and then removed according to the rules.

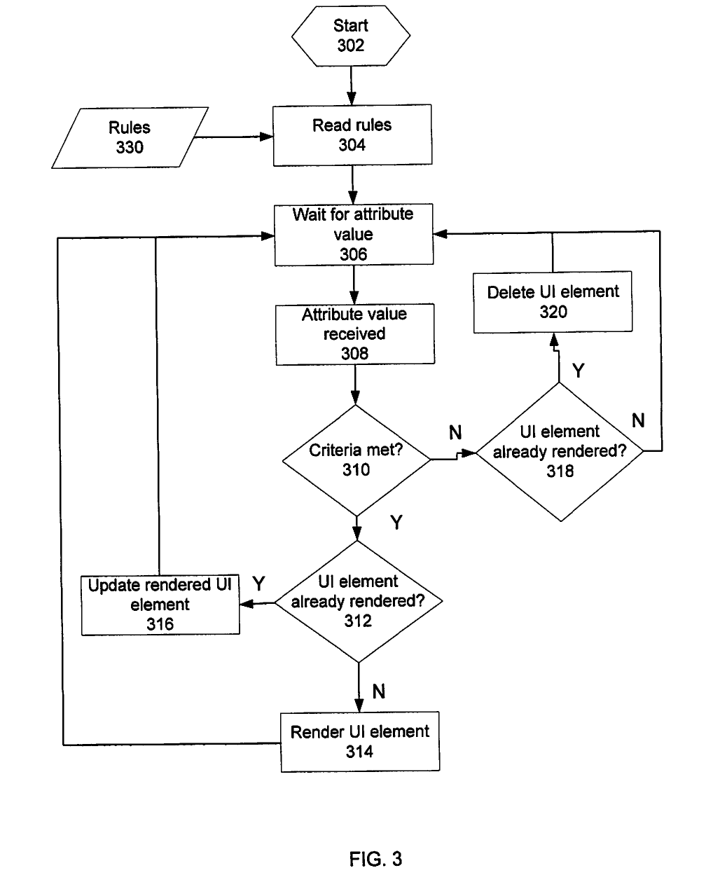

FIG. 3 is a flow chart showing the control flow of a process for automatically rendering user interface elements according to predefined rules, in accordance with one embodiment of the present invention. FIG. 3 depicts the process executed by program logic 150 residing on a client computer such as client 102. The client application may be a web browser, such as web browser 202, executing program logic 150. The flow chart of FIG. 3 begins with step 302 and moves directly to step 304.

In step 304, the program logic 150 reads a plurality of rules 330, wherein each rule specifies criteria that must be met in order to spawn the automatic rendering of a user interface element in the user interface 202. Examples of such rules are provided above.

In step 306, the program logic 150 waits to receive an attribute value. In step 308, an attribute value is received by program logic 150. An attribute value may be a text string or a numerical value. Attribute values may be received via the network 106 using a standard communications protocol such as HTTP or TCP/IP.

In step 310, the rules are evaluated in light of the attribute value received in order to determine whether the attribute value meets the criteria defined in any one rule. If the criteria of a rule are met, then control flows to step 312. Otherwise, control flows to step 318 where it is determined whether a user interface element has already been rendered for this rule. If so, then the user interface element that has already been rendered for this rule is deleted in step 320 and control flows back to step 306 where the program logic 150 waits to receive status information. If a user interface element has not already been rendered for this rule, then control flows directly back to step 306.

In step 312 it is determined whether a user interface element has already been rendered for this rule. If so, then the user interface element that is already rendered for this rule is updated (and may be re-rendered) in step 316 and control flows back to step 306 where the program logic 150 waits to receive a attribute value. In this manner, the user interface element for this rule is periodically rendered in the user interface so as to reflect updated attribute values.

If a user interface element has not already been rendered for this rule, then the user interface element for this rule is rendered for the first time in step 314 and control flows back to step 306.

As explained above, the present invention is advantageous since it displays only the user interface elements for data feeds that meet a certain, predefined criteria. All other user interface elements are deleted or not rendered, thereby freeing valuable desktop space and allowing the user to concentrate his attention on only those user interface elements of importance. The present invention is further advantageous as it eliminates the need for constant re-working or modification of the interface during monitoring due to changes in the attribute values received. The rules 330 automate the process by which user interface elements are displayed or deleted, thereby eliminating the need for input form the administrator using the present invention. Additionally, the present invention allows for automatic, periodic updating of attribute values that are displayed in user interface elements that are rendered in the user interface.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for automated rendering of user interface elements in a user interface, comprising:
reading a plurality of rules, wherein each rule specifies criteria for automatic rendering of a user interface element in the user interface;
receiving an attribute value via a data feed;
determining that the attribute value meets criteria for at least one rule;
automatically rendering a user interface element in the user interface; and
periodically rendering the user interface element in the user interface so as to reflect updated attribute values.

2. The method of claim 1, wherein the step of reading further comprises:
reading a plurality of rules, wherein each rule specifies criteria for automatic rendering of a user interface element in the user interface and wherein criteria consists of a threshold attribute value.

3. The method of claim 2, wherein the step of receiving further comprises:
receiving an attribute value via an HTTP request.

4. The method of claim 3, wherein the step of determining further comprises:
determining that the attribute value meets the threshold attribute value in the criteria of at least one rule.

5. The method of claim 4, wherein the step of automatically rendering further comprises:
automatically rendering a user interface element in the user interface, wherein the user interface element reflects the attribute value that was received.

6. The method of claim 5, wherein the step of periodically rendering further comprises:
periodically rendering the user interface element in the user interface so as to reflect updated attribute values responsive to periodically receiving updated attribute values.

7. The method of claim 6, further comprising:
receiving a second attribute value via the data feed;
determining that the second attribute value does not meet criteria for the at least one rule; and
automatically removing the user interface element in the user interface.

8. The method of claim 7, further comprising:
receiving a third attribute value via the data feed;
determining that the third attribute value meets criteria for at least one rule;
automatically rendering a user interface element in the user interface; and
periodically rendering the user interface element in the user interface so as to reflect updated attribute values.

9. A computer program product comprising a computer usable medium embodying computer usable program code for automated rendering of user interface elements in a user interface, the computer program product comprising:
computer usable program code for reading a plurality of rules, wherein each rule specifies criteria for automatic rendering of a user interface element in the user interface;
computer usable program code for receiving an attribute value via a data feed;
computer usable program code for determining that the attribute value meets criteria for at least one rule;
computer usable program code for automatically rendering a user interface element in the user interface; and
computer usable program code for periodically rendering the user interface element in the user interface so as to reflect updated attribute values.

10. The computer program product of claim 9, wherein the computer usable program code for reading further comprises:
computer usable program code for reading a plurality of rules, wherein each rule specifies criteria for automatic rendering of a user interface element in the user interface and wherein criteria consists of a threshold attribute value.

11. The computer program product of claim 10, wherein the computer usable program code for receiving further comprises:
computer usable program code for receiving at attribute value via an HTTP request.

12. The computer program product of claim 11, wherein the computer usable program code for determining further comprises:
computer usable program code for determining that the attribute value meets the threshold attribute value in the criteria of at least one rule.

13. The computer program product of claim 12, wherein the computer usable program code for automatically rendering further comprises:
computer usable program code for automatically rendering a user interface element in the user interface, wherein the user interface element reflects the attribute value that was received.

14. The computer program product of claim 13, wherein the computer usable program code for periodically rendering further comprises:
computer usable program code for periodically rendering the user interface element in the user interface so as to reflect updated attribute values, responsive to periodically receiving updated attribute values.

15. A computer for automated rendering of user interface elements in a user interface, comprising:
a data repository for storing a plurality of rules, wherein each rule specifies criteria for automatic rendering of a user interface element in the user interface;
a receiver for receiving an attribute value via a data feed;
a processor configured for:
reading the plurality of rules;
determining that the attribute value meets criteria for at least one rule;
automatically rendering a user interface element in the user interface; and
periodically rendering the user interface element in the user interface so as to reflect updated attribute values.

16. The computer of claim 15, wherein criteria consists of a threshold attribute value.

17. The computer of claim 16, wherein an attribute value consists of a text string.

18. The computer of claim 17, wherein the step of determining further comprises:
determining that the attribute value meets the threshold attribute value in the criteria of at least one rule.

19. The computer of claim 18, wherein a user interface element reflects the attribute value that was received.

20. The computer of claim 18, wherein a user interface element comprises any one of a chart, a graph, a meter and a map.
